(19) United States
(12) Patent Application Publication
(10) Pub. No.: US 2015/0020778 A1
(43) Pub. Date: Jan. 22, 2015

(54) FUEL INJECTOR NOZZLE

(71) Applicants: Abhijit P. Upadhye, Columbia, SC (US); Josef Morell, Blythewood, SC (US)

(72) Inventors: Abhijit P. Upadhye, Columbia, SC (US); Josef Morell, Blythewood, SC (US)

(73) Assignee: International Engine Intellectual Property Company LLC, Lisle, IL (US)

(21) Appl. No.: 14/384,188

(22) PCT Filed: Mar. 14, 2013
(86) PCT No.: PCT/US13/31786

§ 371 Date: Sep. 10, 2014

Related U.S. Application Data
(60) Provisional application No. 61/610,666, filed on Mar. 14, 2012.

(51) Int. Cl. F02M 63/02; F02M 63/00; F02M 67/10

(52) U.S. Cl. CPC F02M 63/0265; F02M 67/10; F02M 63/0036
USPC 123/456; 123/445; 239/584; 239/562

(57) ABSTRACT

A fuel injector includes a needle moveable along a central axis to initiate and terminate an injection event, and a nozzle body that receives the needle. The nozzle body includes a needle seat, a nozzle sac, and a passageway between the needle seat and the nozzle sac. The passageway defines a passageway inner surface. The nozzle sac has a curved, non-spherical profile and defines a sac inner surface that extends away from a distal end of the passageway inner surface.

### CROSS REFERENCE TO RELATED APPLICATION

This application claims the benefit of and priority to U.S. Provisional Patent Application No. 61/610,666, filed Mar. 14, 2012, the entire contents of which are hereby incorporated by reference herein.

### TECHNICAL FIELD

The technical field relates generally to fuel injectors, and more particularly to a fuel injector having a non-spherical nozzle sac.

### BACKGROUND

The nozzle portion of a MICROSAC type fuel injector body includes a needle seat against which the fuel injection needle seats to stop a fuel injection event. The needle seat includes at its end a proximal passageway into which the tip of the needle can extend, and a distal, frusto-spherically shaped end portion. Orifices extend through the nozzle body and open into the frusto-spherically shaped end portion. The variations in the absolute and relative geometries of the needle seat, the proximal passageway, the frusto-spherical end portion, and the orifices can affect the overall performance of the fuel injector and, by association, the internal combustion engine into which the fuel injector is installed.

A full discussion of the features and advantages of the present invention is deferred to the following detailed description, which proceeds with reference to the accompanying drawings.

### SUMMARY

In some aspects, a fuel injector includes a needle moveable along a central axis to initiate and terminate an injection event, and a nozzle body that receives the needle. The nozzle body includes a needle seat, a nozzle sac, and a passageway between the needle seat and the nozzle sac. The passageway defines a passageway inner surface. The nozzle sac has a curved, non-spherical profile and defines a sac inner surface that extends away from a distal end of the passageway inner surface.

In other aspects, a fuel injection system includes a source of fuel, a pump operable to pump fuel from the source of fuel, a fuel rail receiving fuel from the pump, and a fuel injector receiving fuel from the fuel rail. The fuel injector includes a needle moveable along a central axis to initiate and terminate an injection event, and a nozzle body that receives the needle. The nozzle body includes a needle seat, a nozzle sac, and a plurality of spray orifices. Each spray orifice has a first end that opens into the nozzle sac, and a second end that opens through an outer surface of the nozzle body. The nozzle sac has a curved, non-spherical profile when viewed in a cross section taken along the central axis.

In still other aspects, a method of injecting fuel from a fuel injector includes raising a needle away from a needle seat to allow high pressure fuel to flow between the needle and the needle seat and into a substantially cylindrical passageway. A nozzle sac is having a curved, non-spherical profile is filled with high pressure fuel. High pressure fuel is guided from the nozzle sac through a plurality of spray orifices, and fuel from the spray orifices is injected into one of an intake manifold and a combustion chamber of an internal combustion engine.

### BRIEF DESCRIPTION OF THE DRAWINGS

To understand the present invention, it will now be described by way of example only, not by way of limitation, with reference to the accompanying drawings in which:

FIG. 1 is a schematic diagram of a fuel injection system including a fuel injector.

FIG. 2 is a section view of a fuel injector body of the fuel injector of FIG. 1;

FIG. 3 is a section view of a nozzle portion of the fuel injector body of FIG. 2;

FIG. 4 is a schematic diagram of the cross-section geometry of the nozzle portion of FIG. 3 illustrating an orifice length, an orifice apex, and an orifice axis;

FIG. 5 is a schematic diagram similar to FIG. 4 illustrating different orifice apex and orifice axis locations; and

FIG. 6 is a schematic diagram similar to FIGS. 4 and 5 illustrating a web diameter.

### DETAILED DESCRIPTION

While this invention is susceptible of embodiments in many different forms, there is shown in the drawings and will herein be described in detail embodiments of the invention with the understanding that the present disclosure is to be considered as an exemplification of the principles of the invention and is not intended to limit the broad aspect of the invention to the embodiments illustrated.

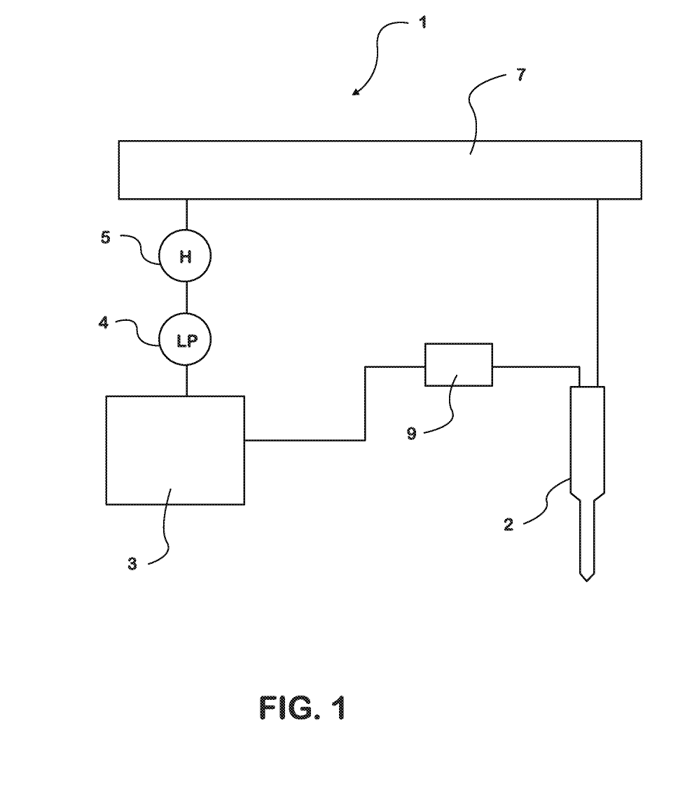

Referring to the Figures, and specifically to FIG. 1, there is shown a fuel injection system 1 including a fuel injector 2 and source of fuel, such as a tank 3. A low pressure pump 4 pumps fuel from the tank 3 to a high pressure pump 5, and the high pressure pump 5 pumps high pressure fuel into a high pressure fuel rail 7. A needle control valve 9 fluidly communicates with the fuel injector 2 for controlling operation of the fuel injector 2. The fuel injector 2 is operable to inject fuel into either an intake manifold or a combustion chamber of an internal combustion engine. The fuel injection system 1 of FIG. 1 is one example of a fuel injection system with which the fuel injector 2 discussed below can be used. Those skilled in the art will readily appreciate that the fuel injector 2 can be used with fuel injection systems having configurations and arrangements of components different from the exemplary fuel injection system 1 shown in FIG. 1.

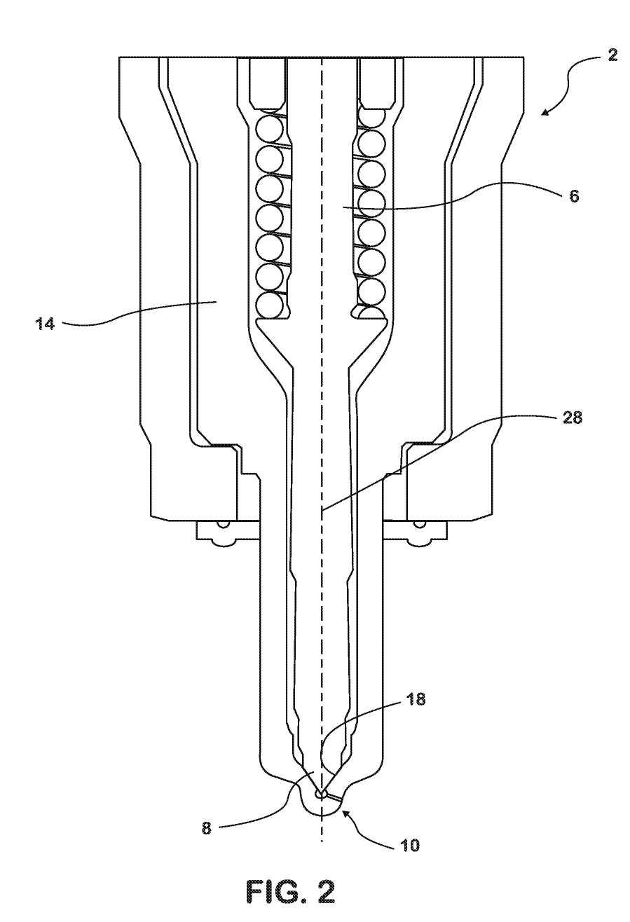

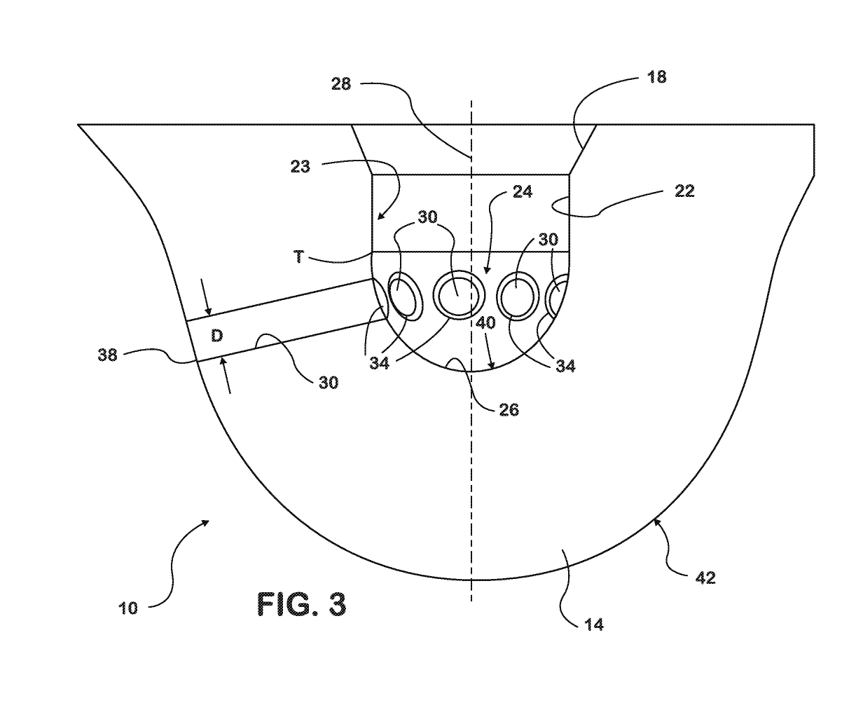

Referring also now to FIGS. 2 and 3, a distal portion of the fuel injector 2 is shown and includes a nozzle body 14 and a needle 6 axially moveable within the nozzle body 14 to initiate and terminate a fuel injection event. A tip 8 of the needle 6 extends into a nozzle 10 formed at a distal end of the nozzle body 14 and is engageable with a generally frusto-conical needle seat 18. The nozzle 10 includes a proximal passageway 22 (FIG. 3) distal from and substantially adjacent to the needle seat 18, and a nozzle sac 24 disposed at a distal end of the proximal passageway 22. In the illustrated embodiment, the proximal passageway 22 is generally cylindrical and defines a generally cylindrical passageway inner surface 23 that extends between the needle seat 18 and the nozzle sac 24. In other embodiments, the proximal passageway 22 may be generally frusto-conical and may therefore define a generally frusto-conical passageway inner surface. In the illustrated embodiment, the nozzle sac 24 defines a smoothly curved sac inner surface 40 that extends substantially tangentially away from the distal end of the passageway inner surface 23, as shown at location T. In other embodiments, the sac inner surface 40 may meet the passageway inner surface 23 at an angle.

The nozzle 10 also defines a longitudinal axis 28 along which the needle seat 18, passageway 22, and nozzle sac 24 are substantially aligned, and along which the needle 6 is axially moveable. A plurality of spray orifices 30 extend through the nozzle body 14. Each spray orifice 30 includes a first end 34 that opens into the nozzle sac 24 through the sac inner surface 40, and a second end 38 that opens through an outer surface 42 of the nozzle body 14. In some embodiments, each orifice 30 is generally circular in cross section and defines an orifice diameter D. In some embodiments, one or more of the orifices 30 may be tapered such that the orifice diameter D at the first end 34 is larger or smaller than the orifice diameter D at the second end 38. In still other embodiments, one or more of the orifices 30 may have a non-circular cross sections such as, for example, an elliptical cross section. When the fuel injector 2 is installed in a direct injection engine, the outer surface 42 of the nozzle body 14 and the second ends 38 of the orifices 30 are located in the combustion chamber of the engine.

In operation, between injection events the tip 8 of the needle 6 is seated against the needle seat 18, thus preventing the flow of fuel into the proximal passageway 22. When the tip 8 of the needle 6 is lifted to initiate an injection event, high pressure fuel flows through the gap between the tip 8 of the needle 6 and the needle seat 18, into the proximal passageway 22 and the nozzle sac 24, through the orifices 30 and into the combustion chamber of the engine.

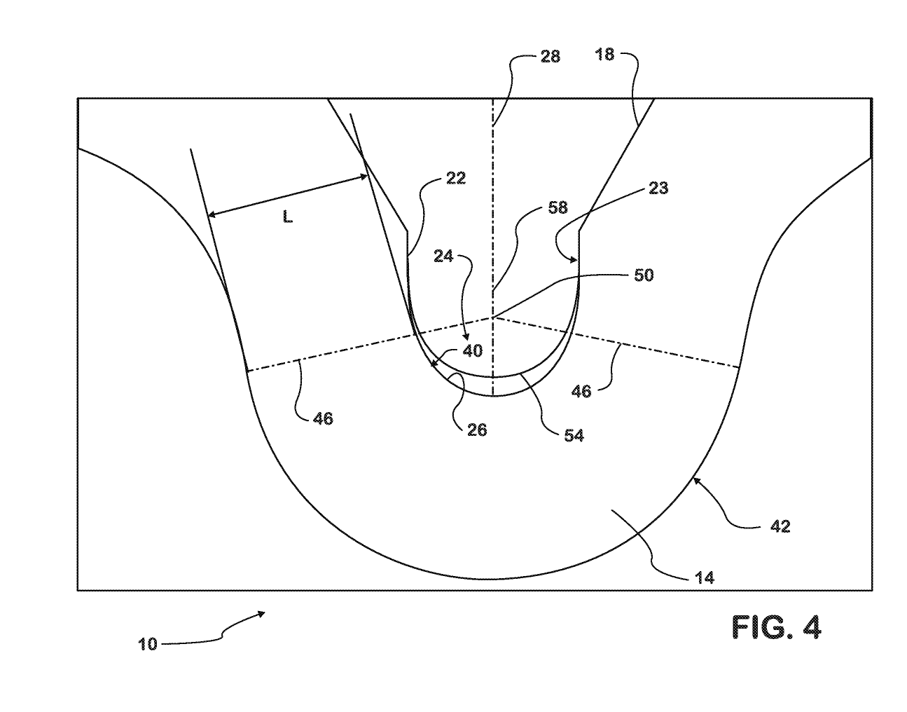

Referring also to FIG. 4, each orifice 30 defines an orifice axis 46 and includes an orifice length L defined as the linear distance between the inner surface 40 and the outer surface 42 of the nozzle body 14 along the orifice axis 46. The ratio of the orifice length L to the orifice diameter D (“the L/D ratio”) is a key parameter in the design of the nozzle 10 because it affects combustion characteristics, nozzle coking characteristics, cavitation, and other characteristics, including the overall efficiency of the fuel injector. Each orifice 30 also defines an apex point 50, which is the point at which the orifice axis 46 of the orifice 30 intersects the longitudinal axis 28 of the nozzle 10. Ideally, the apex point 50 of each orifice 30 is coincident with the apex point 50 of the other orifices 30; however, manufacturing tolerances can result in slight variations of the location of the apex points 50 along the longitudinal axis 28 of the nozzle 10, as discussed further below. The location of the apex point 50 and the resulting spray angle (e.g., the angle between the orifice axis 46 and the longitudinal axis 28) are also key parameters in the design of the nozzle 10, particularly with respect to meeting engine emission requirements.

In some embodiments of the invention, the nozzle sac 24 includes a non-spherical profile 26. For example, in the illustrated embodiment the nozzle sac 24 includes a substantially elliptical profile 26 when viewed in cross section, which is to say the overall geometry of the nozzle sac 24 is that of a substantial ellipse revolved about the longitudinal axis 28 of the nozzle 10. In other embodiments, other non-spherical profiles having variable curvature, such as parabolic or other, higher order, profiles, sinusoidal profiles, logarithmic profiles, and various combinations thereof, may also or alternatively be used. These exemplary non-spherical profiles 26 define the nozzle sac 24 by providing a smooth, continuous, and variably curved transition from the generally cylindrical proximal passageway 22 to the distal end of the nozzle sac 24. More specifically, in embodiments of the non-spherical profile 26, the sac inner surface 40 extends tangentially away from the distal end of the generally cylindrical passageway inner surface 23 and, with varying curvature, converges to form the distal end of the nozzle sac 24.

During the injection of fuel through the fuel injector 2 having the nozzle sac 24, the needle 6 is raised away from the needle seat 18, which allows high pressure fuel to flow between the needle tip 8 and the needle seat 18 and into the proximal passageway 22. The nozzle sac 24 is filled with high pressure fuel, and the high pressure fuel is guided from the nozzle sac 24, through the spray orifices 30, and is injected into either the intake manifold or the combustion chamber of the associated internal combustion engine.

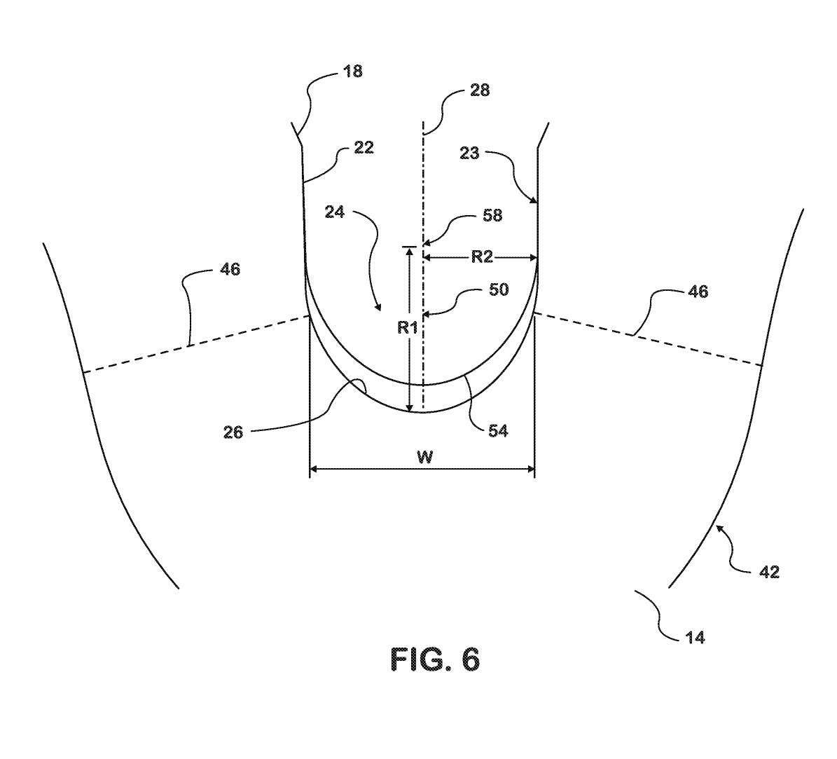

As shown in FIGS. 4 through 6, to illustrate certain aspects of the non-spherical profile 26, the non-spherical profile 26, which in FIGS. 4 through 6 is shown as a substantially elliptical profile, is shown together with a substantially spherical profile 54. In the illustrated examples, both the spherical profile 54 and the non-spherical profile 26 have their centers located at a center point 58. With respect to the illustrated non-spherical profile 26, which is substantially elliptical, the center point 58 is located substantially at the geometric center of a complete and symmetrical ellipse where substantially one half of the complete ellipse defines the geometry of the non-spherical profile 26. Another characteristic of the elliptical profile 26, which characteristic is illustrated only in FIG. 6, is the relationship between a length R1 of the ellipse major radius and a length R2 of the ellipse minor radius. For example, embodiments of the sac 24 having an elliptical profile 26 can include values of R1/R2 of between about 1.05 and about 1.75.

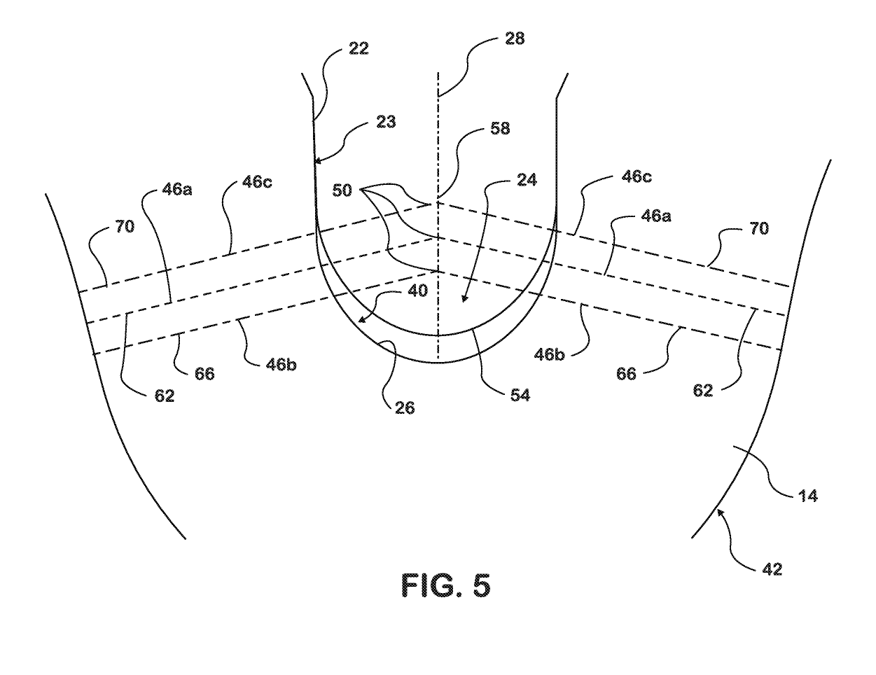

FIG. 5 illustrates how manufacturing tolerances can affect various geometric parameters of the orifices 30 when the nozzle sac 24 is formed with either the spherical profile 54 or the non-spherical profile 26. In FIG. 5, the uniformly dashed line 62 illustrates a nominal location of the orifice axis 46a, the lower, dotted line 66 illustrates a generally minimum or lower location of the orifice axis 46b when the apex point 50 is shifted axially down by, for example, 0.1 mm, and the upper, dot-dashed line 70 illustrates a generally maximum or upper location of the orifice axis 46c when the apex point 50 is shifted axially up by, for example, 0.1 mm. The axial shift of the apex point 50 up or down by 0.1 mm from its nominal location represents exemplary variations due to manufacturing tolerances. In the illustrated embodiment, the nominal orifice diameter D of each orifice 30 is about 0.155 mm. Thus, a 0.1 mm shift away from the nominal apex point 50 location corresponds to about 65% of the nominal spray orifice diameter D. Regardless of variations due to manufacturing tolerances, in each of the illustrated examples, the apex point 50 is located below or distally of the center point 58 of the non-spherical profile 26.

When the apex point 50 of each orifice 30 axially shifts along the longitudinal axis 28 because of manufacturing variability in the manufacturing of the orifices, the orifice length L of the orifice 30 may also change. For example, for both the spherical profile sac 54 and the elliptical profile sac 24, the orifice length L (FIG. 4) at the maximum location of the orifice axis 46c is shorter than the orifice length L at the minimum location of the orifice axis 46b. However, because the sidewalls of the elliptical profile sac 24 are steeper than the sidewalls of the spherical profile sac 54, and therefore more closely match the profile of the outer surface 42 of the nozzle body 14, the difference in orifice length L between the maximum location of the orifice axis 46c and the minimum location of the orifice axis 46b is less for a nozzle sac 24 formed with the non-spherical profile 26 than for a nozzle sac 24 formed with the spherical profile 54.

By way of example only, for one embodiment having an elliptical non-spherical profile 26 with geometry similar to that shown in FIGS. 4 through 6, the variability ((Lmax−Lmin)/Lnominal) of the orifice length L between the maximum location of the orifice axis 46c (corresponding to Lmin) and the minimum location of the orifice axis 46b (corresponding to Lmax) is less than about 4%, and in some embodiments may be about 3.63%, of the nominal orifice length (Lnominal). In contrast, the variability of the orifice length L for a sac 24 having the spherical profile 54 shown in FIGS. 4 through 6 is about 8.75%. As a result, for an orifice 30 having a given diameter D, by using a non-spherical profile sac, such as the elliptical profile sac 24, instead of a spherical profile sac, the potential variation in the L/D ratio among the different spray orifices due to differences in the location of their respective apex points 50 can be reduced by about 55%.

Using a non-spherical profile 26 to reduce the potential variability of the orifice length L also reduces the variability in the L/D ratio. Reducing variability in the L/D ratio can reduce the risk of nozzle coking and cavitation, and can reduce variations in spray plume pattern and overall nozzle efficiency from nozzle to nozzle, which in turn can improve the combustion process and overall engine efficiency.

Referring to FIG. 6, forming the nozzle sac 24 with the non-spherical profile 26 also reduces variability in the web diameter W of the nozzle 10. The web diameter W is defined as the diameter of the sac 24 at the location where the orifice axes 46 extend into the sac 24. For a nozzle 10 having a set number of orifices 30 positioned at a set spray angle and having a set orifice diameter D, as the orifices 30 move toward the minimum location of the orifice axis 46b (see FIG. 5), the web diameter W is reduced. As the web diameter W is reduced the first ends 34 (see FIG. 3) of the orifices 30 become more tightly grouped, which results in less material between the first ends 34 of adjacent orifices 30. This reduction in material and spacing can increase the risk of washouts and orifice overlaps. Compared to a nozzle sac 24 having the spherical profile 54, a nozzle sac 24 having the non-spherical profile 26 results in less reduction of the web diameter W as the orifices 30 approach the minimum location of the orifice axis 46b due to manufacturing tolerances. As a result, the risk of orifice washouts and orifice overlaps can be reduced in the nozzle sac 24 having the non-spherical profile 26 compared to a nozzle sac 24 having the spherical profile 54. Furthermore, for a given nozzle 10 configuration, the non-spherical sac 24 may allow for more orifices 30 or larger orifices 30 while still maintaining sufficient structural integrity between adjacent orifices 30.

By way of example only, for one embodiment of a nozzle sac 24 formed with a non-spherical profile 26 having geometry similar to that shown in FIGS. 4 through 6 (e.g., a substantially elliptical profile), the variability of the web diameter W ((Wmax−Wmin)/Wnominal) between the maximum location of the orifice axis 46c (corresponding to Wmax) and the minimum location of the orifice axis 46b (corresponding to Wmin) is less than about 20%, and in some embodiments may be about 18.8%, of the nominal web diameter W associated with the nominal orifice axis location 46a. In contrast, the variability of the web diameter W for the spherical profile sac 54 shown in FIGS. 4 through 6 is about 30.9%.

For the illustrated nozzle sac 24 having the elliptical, non-spherical profile 26, increasing the ellipse major diameter increases the slope where the orifice 30 opens into the sac 24, which can further reduce the variation in orifice length L. However, increasing the ellipse major diameter also increases the overall volume of the nozzle sac 24, which may represent an undesirable increase in the quantity of unburned fuel that remains in the nozzle sac 24 after each injection event. Thus, there may be certain design tradeoff considerations between minimizing the variation in orifice length L but not exceeding a certain acceptable amount of unburned fuel remaining in the sac 24 between injection events.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A fuel injector comprising:
a needle moveable along a central axis to initiate and terminate an injection event; and,
a nozzle body that receives the needle, the nozzle body including a needle seat, a nozzle sac, and a passageway between the needle seat and the nozzle sac, the passageway defining a passageway inner surface, and the nozzle sac having a curved, non-spherical profile and defining a sac inner surface that extends away from a distal end of the passageway inner surface.

2. The fuel injector of claim 1, wherein the nozzle body includes a nozzle having an outer surface and defining a plurality of spray orifices extending through the nozzle body from the outer surface to the sac inner surface.

3. The fuel injector of claim 4, wherein each spray orifice defines an orifice axis, and each orifice axis intersects the central axis at a respective apex point, and wherein for an axial shift of the apex point of one of the orifice axes away from a nominal apex point location by an amount equal to about 65% of a spray orifice diameter (D), a variability of a length (L) of the respective spray orifice is less than about 4%.

4. The fuel injector of claim 2, wherein each spray orifice has a substantially circular cross section.

5. The fuel injector of claim 1, wherein the non-spherical profile is substantially elliptical when viewed in a cross section taken along the central axis.

6. The fuel injector of claim 5, wherein the substantially elliptical non-spherical profile includes a major radius length R1 and a minor radius length R2, and wherein a value of R1/R2 is between about 1.05 and 1.75.

7. The fuel injector of claim 1, wherein the passageway inner surface is substantially cylindrical, and wherein the sac inner surface extends substantially tangentially away from the distal end of the passageway inner surface.

8. A fuel injection system comprising:
a source of fuel;
a pump operable to pump fuel from the source of fuel;
a fuel rail receiving fuel from the pump; and
a fuel injector receiving fuel from the fuel rail, the fuel injector including
a needle moveable along a central axis to initiate and terminate an injection event; and,
a nozzle body that receives the needle, the nozzle body including a needle seat, a nozzle sac, and a plurality of spray orifices, each spray orifice having a first end that opens into the nozzle sac, and a second end that opens through an outer surface of the nozzle body, the nozzle sac having a curved, non-spherical profile when viewed in a cross section taken along the central axis.

9. The fuel injection system of claim 8, wherein the nozzle body includes a passageway between the needle seat and the nozzle sac, the passageway defining a passageway inner surface, and the nozzle sac defining a sac inner surface that extends away from a distal end of the passageway inner surface.

10. The fuel injection system of claim 9, wherein the passageway inner surface is substantially cylindrical, and wherein the sac inner surface extends substantially tangentially away from the distal end of the passageway inner surface.

11. The fuel injection system of claim 8, wherein each spray orifice defines an orifice axis that intersects the central axis at an apex point, and wherein for an axial shift of the apex point away from a nominal apex point location by an amount equal to about 65% of a spray orifice diameter (D), a variability of a length (L) of the spray orifice is less than about 4%.

12. The fuel injection system of claim 8, wherein each spray orifice has a substantially circular cross section.

13. The fuel injection system of claim 8, wherein the non-spherical profile is substantially elliptical and includes a major radius length R1 and a minor radius length R2, and wherein a value of R1/R2 is between about 1.05 and 1.75.

14. A method of injecting fuel from a fuel injector, the method comprising:
raising a needle away from a needle seat and thereby allowing high pressure fuel to flow between the needle and the needle seat and into a substantially cylindrical passageway;
filling a nozzle sac having a curved, non-spherical profile with high pressure fuel;
guiding high pressure fuel from the nozzle sac through a plurality of spray orifices; and
injecting fuel from the spray orifices into one of an intake manifold and a combustion chamber of an internal combustion engine.

15. The method of claim 14, wherein the needle moves along a central axis, and wherein filling the nozzle sac includes filling a nozzle sack having a substantially elliptical profile when viewed in a cross section taken along the central axis.
